(19) United States
(12) Patent Application Publication
(10) Pub. No.: US 2013/0256245 A1
(43) Pub. Date: Oct. 3, 2013

(54) PLASTIC FRAME, FRAME UNIT AND FASTENER THEREOF

(71) Applicants: Yicheng Kuo, Shenzhen (CN); Shih-Hsiang Chen, Shenzhen (CN); Gang Yu, Shenzhen (CN); Gege Zhou, Shenzhen (CN); Weifeng Chen, Shenzhen (CN)

(72) Inventors: Yicheng Kuo, Shenzhen (CN); Shih-Hsiang Chen, Shenzhen (CN); Gang Yu, Shenzhen (CN); Gege Zhou, Shenzhen (CN); Weifeng Chen, Shenzhen (CN)

(73) Assignee: Shenzhen China Star Optoelectronics Technology Co., Ltd., Shenzhen (CN)

(21) Appl. No.: 13/514,978

(22) PCT Filed: Apr. 17, 2012
(86) PCT No.: PCT/CN12/74158

§ 371 Date: Jun. 9, 2012

(30) Foreign Application Priority Data
Mar. 27, 2012 (CN) 201210083496.4

(51) Int. Cl. H04N 5/00

(52) U.S. Cl. 211/26

(57) ABSTRACT

The present invention discloses a plastic frame, a frame unit and a fastener thereof. The frame unit is strip-shaped and has at least one end having an assembling portion. The fastener is used to fix two of the connected assembling portions, and the assembling portions of the frame units are connected and fixed by engaging two surfaces thereof with two surfaces of the fastener. The present invention achieves modularization of plastic frame by providing the frame units and fasteners and assembling them into the plastic frame, which not only saves cost of molding equipment, but also ensures a certain level of fixing strength and flatness.

### BACKGROUND OF THE INVENTION

1. Field of the Invention

The present invention relates to an assembling component for liquid crystal display device, especially to a plastic frame, a frame unit and a fastener thereof.

2. Description of the Related Art

Generally speaking, a conventional liquid crystal display module includes components such as a front frame, a liquid crystal display panel, a plastic frame, a backlight module and a back board. The backlight module may be a side-light type backlight module and include optical films, a light guide plate and a light bar. The front frame, the plastic frame and the back board are connected together to form a holding room, and the liquid crystal display panel and the backlight module are to be mounted in the holding room to construct the liquid crystal display module.

The plastic frame is mainly to fix and hold the liquid crystal display panel and the light guide plate of the backlight module so as to prevent the liquid crystal display panel and the light guide plate of the backlight module from shaking or flipping. Although different types of liquid crystal display modules have similar plastic frame structures, but size of the plastic frame of different liquid crystal display modules may vary by the sizes of the liquid crystal display panels, therefore, the design of the molding device has to be changed according to the frame size, which undoubtedly increases molding cost.

In order to save the cost, manufacturers design a modular structure for plastic frame by providing multiple frame units and assembling them into one complete plastic frame to meet the requirement of different types of liquid crystal display modules. However, such a modular structure of plastic frame still has a problem of poor flatness on the connection part between the frame units.

Hence, it is necessary to provide a plastic frame, a frame unit and a fastener thereof to overcome the problems existing in the conventional technology.

### SUMMARY OF THE INVENTION

In consideration of the shortcomings of the conventional technology, a primary object of the present invention is to provide a plastic frame, a frame unit and a fastener thereof such that the plastic frame can be assembled into different sizes through hook engagements between frame units and corresponding fasteners and further meet the requirements of different types of liquid crystal display modules and ensure that the connection between the frame units and fasteners has certain strength and flatness at the same time.

In order to achieve to foregoing object of the present invention, the present invention provides a plastic frame having:

at least two frame units, and each of the frame units is strip-shaped and has at least one end having an assembling portion; the assembling portion has a first concave portion and a second concave portion, wherein a surface of the first concave portion and a surface of the second concave portion are connected and define a first angle; the surface of the first concave portion has a first engaging portion formed thereon, and the surface of the second concave portion has a second engaging portion formed thereon; the assembling portion is used to be correspondingly connected to the assembling portion of another one of the frame units; and
at least one fastener used to fix two of the connected assembling portions, wherein the fastener has a first board portion and a second board portion, the first board portion and the second board portion are connected and define a second angle; the first board portion has a third engaging portion formed thereon, and the third engaging portion is correspondingly engaged with the first engaging portions of the first concave portions of two of the connected assembling portions of the frame units; the second board portion has a fourth engaging portion formed thereon, and the fourth engaging portion is correspondingly engaged with the second engaging portions of the second concave portions of two of the assembling portions of the frame units.

In one embodiment of the present invention, each of the frame units is a plastic strip-shaped structure having an L-shaped cross-section.

In one embodiment of the present invention, a length of the fastener is equal to the total length of two of the connected assembling portions.

In one embodiment of the present invention, the first angle is equal to the second angle.

In one embodiment of the present invention, the first angle and the second angle are both 90 degrees.

In one embodiment of the present invention, each of the first, the second, the third and the fourth engaging portions is a strip-shaped protrusion with the same shape and having a contact surface, wherein the contact surface of the first engaging portion correspondingly abuts the surface of the third engaging portion; and the surface of the second engaging portion correspondingly abuts the surface of the fourth engaging portion.

In one embodiment of the present invention, each of the first, the second, the third and the fourth engaging portions is a strip-shaped protrusion having a triangle-shaped cross-section.

In one embodiment of the present invention, the assembling portions of the frame units and the fastener have a space therebetween.

In one embodiment of the present invention, each of the first and the second engaging portions is a strip-shaped protrusion with the same shape; each of the third and the fourth engaging portions is a groove corresponding to the shape of the strip-shaped protrusion.

In one embodiment of the present invention, each of the first and the second engaging portions is a strip-shaped protrusion having a rectangle-shaped cross-section.

In one embodiment of the present invention, each of the first and the second engaging portions is a strip-shaped protrusion having a trapezoid-shaped cross-section.

In one embodiment of the present invention, each of the first and the second engaging portions is a strip-shaped protrusion having a triangle-shaped cross-section.

In one embodiment of the present invention, each of the first and the second engaging portions is a groove having the same shape; and each of the third and the fourth portions is a strip-shaped protrusion corresponding to the shape of the groove.

In one embodiment of the present invention, each of the first and the second engaging portions is a groove having a rectangle-shaped cross-section.

In one embodiment of the present invention, each of the first and the second engaging portions is a groove having a trapezoid-shaped cross-section.

The present invention further provides another frame unit being strip-shaped and having at least one end having an assembling portion; the assembling portion has a first concave portion and a second concave portion, wherein the first concave portion and the second concave portion are connected and define a first angle; the surface of the first concave portion has a first engaging portion formed thereon, and the surface of the second concave portion has a second engaging portion formed thereon.

The present invention further provides a fastener used to fix two connected assembling portions of the foregoing frame units, wherein the fastener has a first board portion and a second board portion, the first board portion and the second board portion are connected and define a second angle; the first board portion has a third engaging portion formed thereon; the second board portion has a fourth engaging portion formed thereon.

The present invention is to modularize the manufacture of plastic frames by providing a plurality of frame units and fasteners to assemble into a plastic frame. The assembling portions of the frame units are connected and fixed by engaging two surfaces thereof with two surfaces of the fastener so as to achieve a certain level of fixing strength and flatness. The modular design can also save cost on molding equipment.

### BRIEF DESCRIPTION OF THE DRAWINGS

FIG. 1 is a partial perspective view of a plastic frame in accordance with the present invention;

FIG. 2A is a perspective view of a first embodiment of a frame unit and a fastener of the present invention before being assembled;

FIG. 2B is a side view of the first embodiment of a frame unit and a fastener of the present invention after being assembled;

FIG. 3A is a perspective view of a second embodiment of a frame unit and a fastener of the present invention before being assembled;

FIG. 3B is a side view of the second embodiment of a frame unit and a fastener of the present invention after being assembled;

FIG. 4A is a perspective view of a third embodiment of a frame unit and a fastener of the present invention before being assembled;

FIG. 4B is a side view of the third embodiment of a frame unit and a fastener of the present invention after being assembled;

FIG. 5A is a perspective view of a fourth embodiment of a frame unit and a fastener of the present invention before being assembled;

FIG. 5B is a side view of the fourth embodiment of a frame unit and a fastener of the present invention after being assembled;

FIG. 6A is a perspective view of a fifth embodiment of a frame unit and a fastener of the present invention before being assembled;

FIG. 6B is a side view of the fifth embodiment of a frame unit and a fastener of the present invention after being assembled;

FIG. 7A is a perspective view of a sixth embodiment of a frame unit and a fastener of the present invention before being assembled; and

FIG. 7B is a side view of the sixth embodiment of a frame unit and a fastener of the present invention after being assembled.

### DETAILED DESCRIPTION OF THE PREFERRED EMBODIMENTS

Following description of each embodiment is referring to the accompanying drawings so as to illustrate practicable specific embodiments in accordance with the present invention. The directional terms described in the present invention, such as upper, lower, front, rear, left, right, inner, outer, side and etc., are only directions referring to the accompanying drawings, so that the used directional terms are used to describe and understand the present invention, but the present invention is not limited thereto.

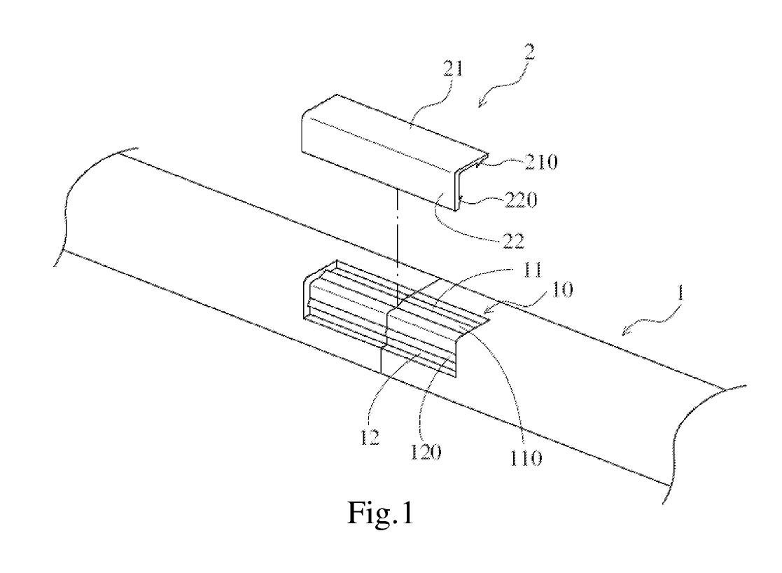

Please refer to FIG. 1, wherein FIG. 1 is a partial perspective view of a plastic frame in accordance with the present invention. The plastic frame of the present invention is constructed by at least two frame units 1 and at least one fastener 2.

With reference to FIG. 1, each of the frame unit 1 is strip-shaped, and each of the frame units 1 has at least one end having an assembling portion 10. In more details, in this embodiment, each of the frame units 1 is a plastic strip-shaped structure having an L-shaped cross-section. In this embodiment, the assembling portion 10 has a first concave portion and a second concave portion 12. A surface of the first concave portion 11 and a surface of the second concave portion 12 are connected together and define a first angleθ 1, wherein the surface of the first concave portion 11 has a first engaging portion 110 formed thereon, and the surface of the second concave portion 12 has a second engaging portion 120 formed thereon. The assembling portion 10 is used to be connected to the assembling portion 10 of another frame unit 1, the term “connect” herein means that the end of the frame unit 1 abuts against the end of another frame unit 1 such that the first concave portion 11 of the assembling portion 10 of the frame unit 1 is coplanar connected with the first concave portion 11 of the assembling portion 10 of another frame unit 1; meanwhile, the second concave portion 12 of the assembling portion 10 of the frame unit 1 is also coplanar connected with the second concave portion 12 of the assembling portion 10 of another frame unit 1, as shown in FIG. 1.

As shown in FIG. 1, the fastener 2 is mainly used for fixing two of the connected frame units 1. In order to be flatly mounted on two of the connected assembling portions 10, a length of the fastener 2 is preferably equal to or less than the total length of two of the connected assembling portions 10. In more details, the fastener 2 has a first board portion 21 and a second board portion 22, and the first board portion 21 are and second board portion 22 are connected together and define a second angleθ 2, wherein the first board portion 21 has a third engaging portion 210 formed thereon, and the third engaging portion 210 is used to be correspondingly engaged with the first engaging portions 110 of the first concave portions 11 of the two of the connected assembling portions 10 of the frame units 1; and the second board portion 22 has a fourth engaging portion 220 formed thereon, and the fourth engaging portion 220 is used to be correspondingly engaged with the second engaging portions 120 of the second concave portions 12 of the two of the connected assembling portions 10 of the frame units 1. In this embodiment, the second angleθ 2 is equal to the first angle θ 1 and is preferably 90 degrees.

The fastener 2 may be a plastic component made of materials as the same as the frame unit 1 or other component having certain resilience. When mounting the fastener 2 on the two of the connected assembling portions 10, the fastener 2 first are positioned on the assembling portions 10, wherein the first board portion 21 corresponds to the first concave portion 11, and the second board portion 22 corresponds to the second concave portion 12; then apply a press force to the fastener 2 such that the third engaging portion 210 of the first board portion 21 is engaged with the first engaging portion 110 of the first concave portion 11, and the fourth engaging portion 220 of the second board portion 22 is engaged with the second engaging portion 120 of the second concave portion 12; meanwhile, the first board portion 21 and the second board portion 22, as a result, are mounted in the first concave portion 11 and the second concave portion 12, respectively, and thereby the connection between the two of the connected frame units 1 has a flat surface.

The mounting of the fastener 2 enhances the strength and flatness between the frame units 1. As for the embodiment shown in FIG. 1, the fastener 2 mounted on the two of the connected frame units 1 can prevent the frame units 1 from rotating against each other and only allow the frame units 1 to move along their length direction. In a practical manufacturing process of the plastic frame, small space adjustment between two of the frame units 1 can be achieved to meet the requirement of different lengths. The frame unit 1 may have a transverse extension (not shown in the figure) to be connected with other similar components so as to construct a rectangular plastic frame. The end of the extension may also have the same structure as the above-mentioned assembling portion 10 to connect to other frame unit 1.

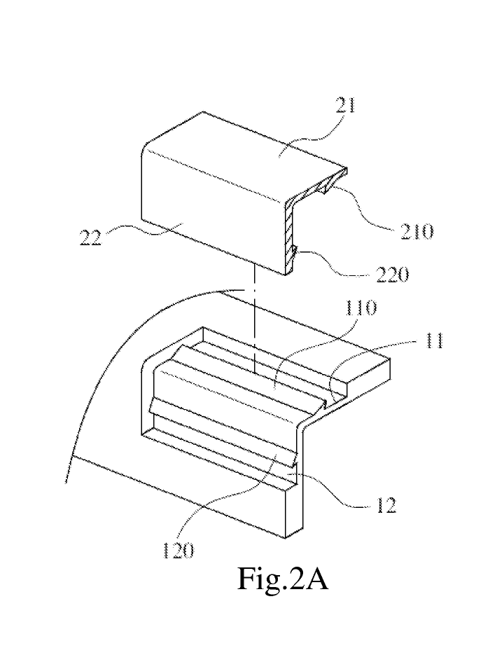

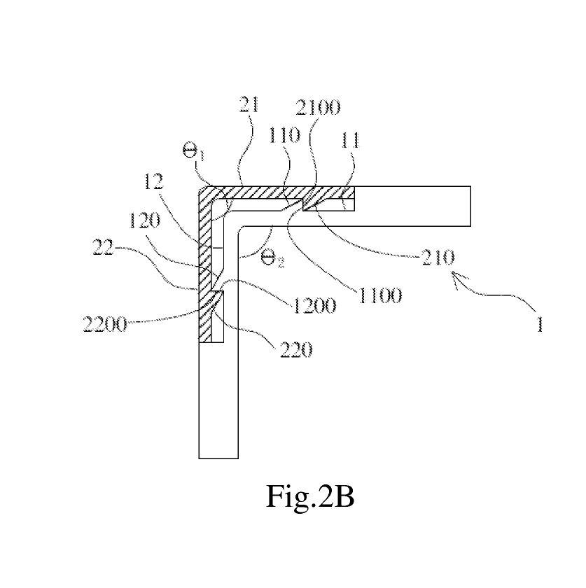

With reference to FIGS. 2A and 2B, FIG. 2A is a perspective view of a first embodiment of the frame unit and the fastener of the present invention before being assembled; FIG. 2B is a side view of the first embodiment of the frame unit and the fastener of the present invention after being assembled. With reference to the figures, the first engaging portion 110, the second engaging portion 120, the third engaging portion 210 and the fourth engaging portion 220 each is a strip-shaped protrusion having the same shape and has a contact surface (1100, 1200, 2100, 2200). The contact surface 1100 of the first engaging portion 110 correspondingly abuts the contact surface 2100 of the third engaging portion 210; and the contact surface 1200 of the second engaging portion 120 correspondingly abuts the contact surface 2200 of the fourth engaging portion 220. In this embodiment, the assembling portions 10 of the frame units 1 and the fastener 2 have a space therebetween, that is, there is a space between the first concave portion 11 and the second concave portion 12 of the assembling portion 10 and the first board portion 21 and the second board portion 22 of the fastener 2. As shown in FIG. 2B, the space may be further filled with adhesive material to further enhance the connection between the fastener 2 and the frame units 1. Besides, it can be seen from FIG. 1 that each of the first engaging portion 110, the second engaging portion 120, the third engaging portion 210 and the fourth engaging portion 220 is a strip-shaped protrusion having a triangle-shaped cross-section.

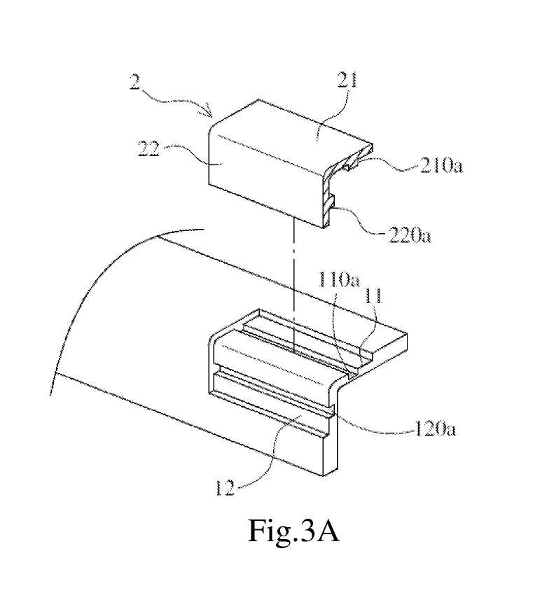

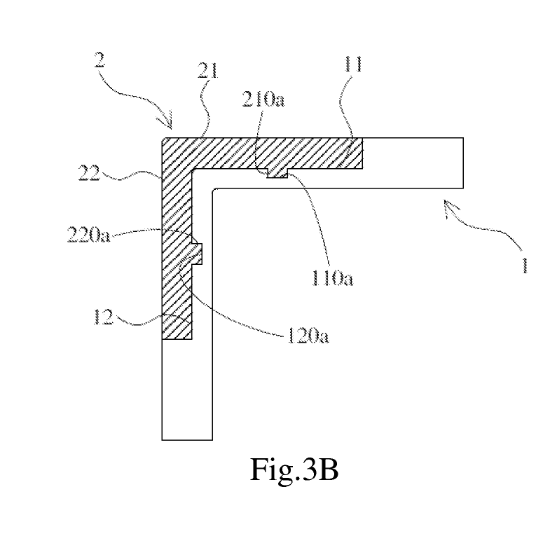

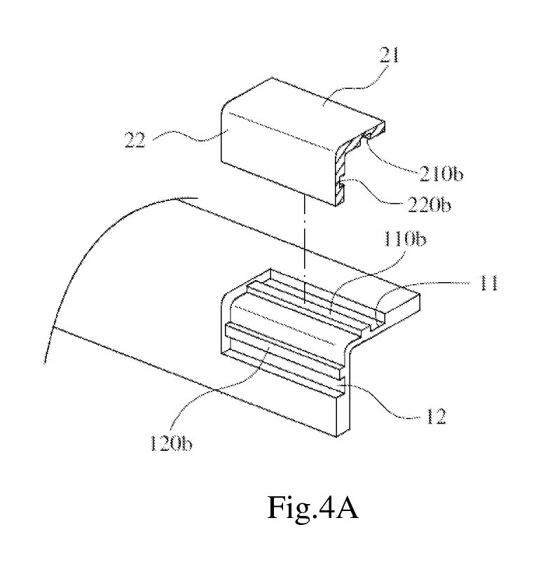

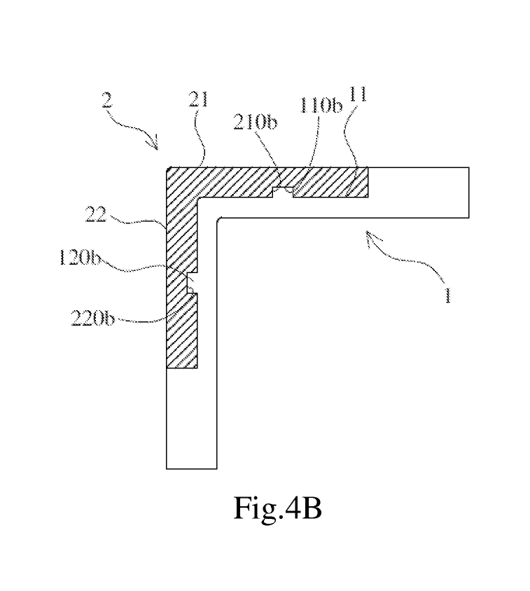

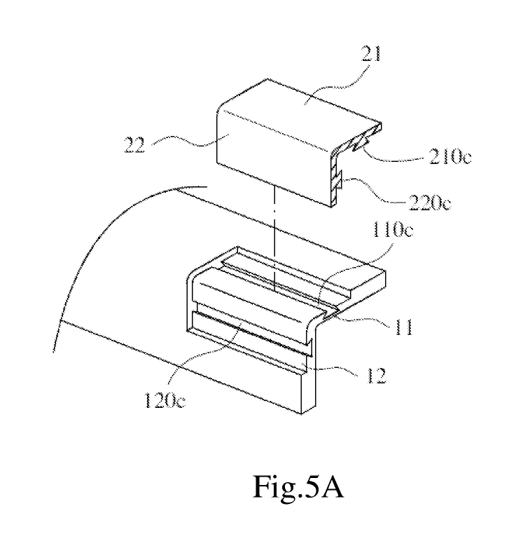

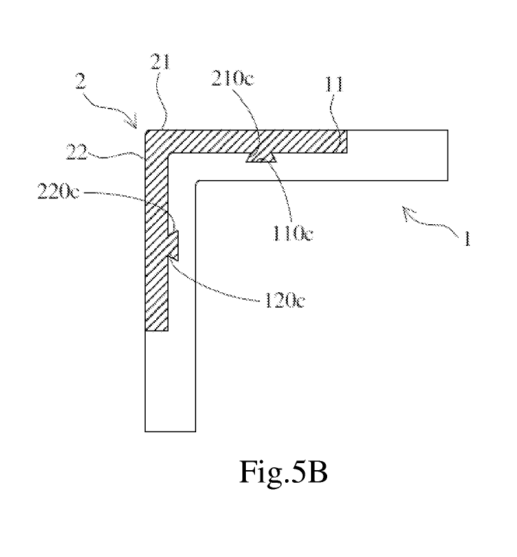

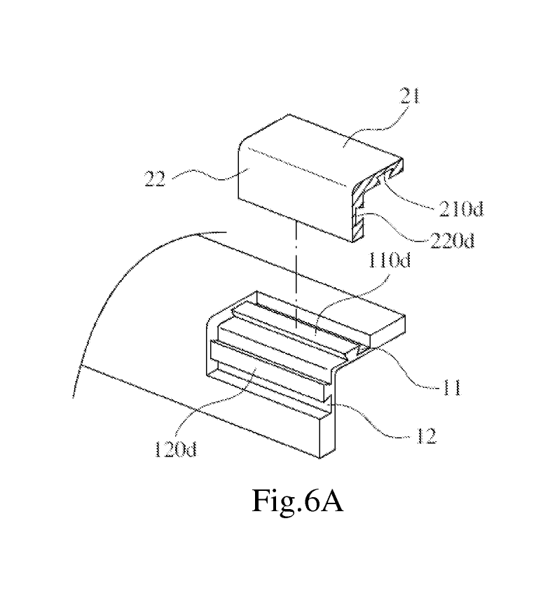

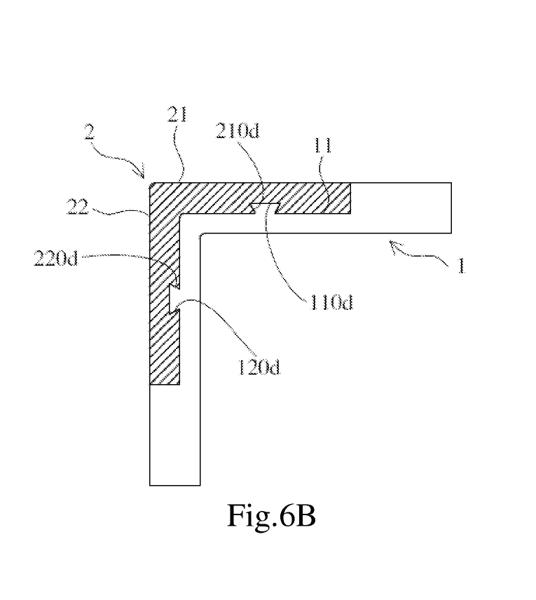

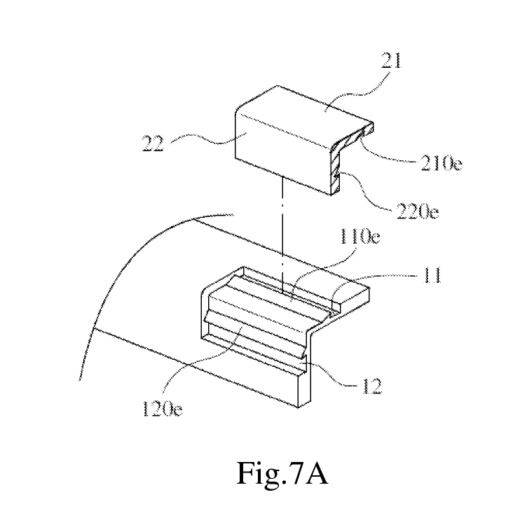

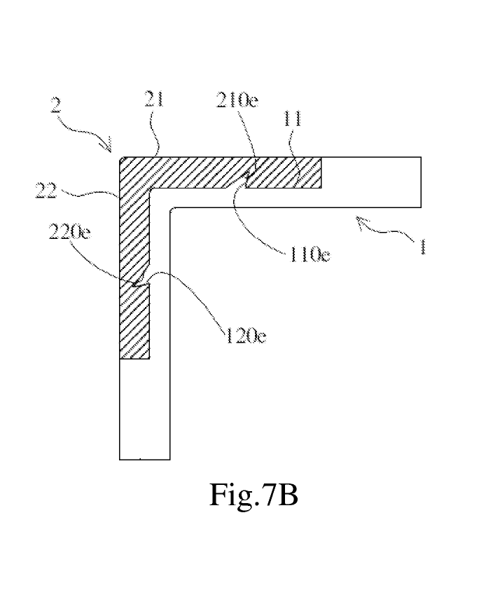

In addition to the first embodiment, the engaging structure between the frame unit 1 and the fastener 2 of the present invention may be designed as other engaging forms without having any space left therein. With reference to FIGS. 3A and 3B, each of the first engaging portion 110a and the second engaging portion 120a is a groove having the same shape and having a rectangle-shaped cross-section; and each of the third engaging portion 210a and the fourth engaging portion 220a is a strip-shaped protrusion corresponding to the shape of the groove. On the contrary, with reference to FIGS. 4A and 4B, each of the first engaging portion 110b and the second engaging portion 120b is a strip-shaped protrusion having the same shape and having a rectangle-shaped cross-section; and each of the third engaging portion 210b and the fourth engaging portion 220b is a groove corresponding to the shape of the strip-shaped protrusion. Otherwise, with reference to FIGS. 5A and 5B, each of the first engaging portion 110c and the second engaging portion 120c is a groove having the same shape and having a trapezoid-shaped cross-section; and each of the third engaging portion 210c and the fourth engaging portion 220c is a strip-shaped protrusion corresponding to the shape of the groove. On the contrary, with reference to FIGS. 6A and 6B, each of the first engaging portion 110d and the second engaging portion 120d is a strip-shaped protrusion having the same shape and having a trapezoid-shaped cross-section; and each of the third engaging portion 210d and the fourth engaging portion 220d is a groove corresponding to the shape of the strip-shaped protrusion. Otherwise, with reference to FIGS. 7A and 7B, each of the first engaging portion 110e and the second engaging portion 120e is a strip-shaped protrusion having the same shape and having a triangle-shaped cross-section; and each of the third engaging portion 210e and the fourth engaging portion 220e is a groove corresponding to the shape of the strip-shaped protrusion.

Besides, the engaging portions of the frame units and the fastener 2 are not limited to the above-mentioned types of strip-shaped protrusion or groove. The engaging portions of the frame unit 1 may be designed in different forms, such as one of the engaging portions has a hook structure and the other one of the engaging portions is a through hole or a groove structure, as long as the engaging portions of the corresponding fastener 2 have a corresponding structure that matches.

By the above description, comparing with the modular structure of conventional plastic frames that have a shortcoming of poor flatness of the connection between the frame units, the present invention provides a plastic frame, frame units and a fastener thereof that the plastic frame can be constructed to have different sizes through a way of correspondingly engaging the frame units and fasteners with each other, and meanwhile ensure a certain level of fixing strength and flatness.

The present invention has been described with a preferred embodiment thereof and it is understood that many changes and modifications to the described embodiment can be carried out without departing from the scope and the spirit of the invention that is intended to be limited only by the appended claims.

What is claimed is:

1. A plastic frame comprising:
at least two frame units, and each of the frame units is strip-shaped and has at least one end having an assembling portion; the assembling portion has a first concave portion and a second concave portion, wherein a surface of the first concave portion and a surface of the second concave portion are connected and define a first angle; the surface of the first concave portion has a first engaging portion formed thereon, and the surface of the second concave portion has a second engaging portion formed thereon; the assembling portion is used to be correspondingly connected to the assembling portion of another one of the frame units; and
at least one fastener used to fix two of the connected assembling portions, wherein the fastener has a first board portion and a second board portion, the first board portion and the second board portion are connected and define a second angle; the first board portion has a third engaging portion formed thereon, and the third engaging portion is correspondingly engaged with the first engaging portions of the first concave portions of two of the connected assembling portions of the corresponding frame units; the second board portion has a fourth engaging portion formed thereon, and the fourth engaging portion is correspondingly engaged with the second engaging portions of the second concave portions of two of the connected assembling portions of the frame units.

2. The plastic frame as claimed in claim 1, wherein each of the frame units is a plastic strip-shaped structure having an L-shaped cross-section.

3. The plastic frame as claimed in claim 1, wherein a length of the fastener is equal to the total length of two of the connected assembling portions.

4. The plastic frame as claimed in claim 1, wherein the first angle is equal to the second angle.

5. The plastic frame as claimed in claim 1, wherein the first angle and the second angle are both 90 degrees.

6. The plastic frame as claimed in claim 1, wherein each of the first, the second, the third and the fourth engaging portions is a strip-shaped protrusion with the same shape and having a contact surface, wherein the contact surface of the first engaging portion correspondingly abuts the surface of the third engaging portion; and the surface of the second engaging portion correspondingly abuts the surface of the fourth engaging portion.

7. The plastic frame as claimed in claim 6, wherein each of the first, the second, the third and the fourth engaging portions is a strip-shaped protrusion having a triangle-shaped cross-section.

8. The plastic frame as claimed in claim 6, wherein the assembling portions of the frame units and the fastener have a space therebetween.

9. The plastic frame as claimed in claim 1, wherein each of the first and the second engaging portions is a strip-shaped protrusion with the same shape; each of the third and the fourth engaging portions is a groove corresponding to the shape of the strip-shaped protrusion.

10. The plastic frame as claimed in claim 9, wherein each of the first and the second engaging portions is a strip-shaped protrusion having a rectangle-shaped cross-section.

11. The plastic frame as claimed in claim 9, wherein each of the first and the second engaging portions is a strip-shaped protrusion having a trapezoid-shaped cross-section.

12. The plastic frame as claimed in claim 9, wherein each of the first and the second engaging portions is a strip-shaped protrusion having a triangle-shaped cross-section.

13. The plastic frame as claimed in claim 1, wherein each of the first and the second engaging portions is a groove having the same shape; and each of the third and the fourth portions is a strip-shaped protrusion corresponding to the shape of the groove.

14. The plastic frame as claimed in claim 13, wherein each of the first and the second engaging portions is a groove having a rectangle-shaped cross-section.

15. The plastic frame as claimed in claim 13, wherein each of the first and the second engaging portions is a groove having a trapezoid-shaped cross-section.

16. A frame unit being strip-shaped and having at least one end having an assembling portion; the assembling portion has a first concave portion and a second concave portion; the first concave portion and the second concave portion are connected and define a first angle; the surface of the first concave portion has a first engaging portion formed thereon, and the surface of the second concave portion has a second engaging portion formed thereon.

17. A fastener for frame units, which is used to fix two connected assembling portions of the frame units as claimed in claim 16, wherein the fastener has a first board portion and a second board portion, the first board portion and the second board portion are connected and define a second angle; the first board portion has a third engaging portion formed thereon and being used to be correspondingly engaged with the first engaging portions of two of the connected assembling portions of the frame units; the second board portion has a fourth engaging portion formed thereon and being used to be correspondingly engaged with the second engaging portions of the second concave portions of two of the assembling portions of the frame units.
